(19) United States
(12) Patent Application Publication
(10) Pub. No.: US 2002/0073911 A1
(43) Pub. Date: Jun. 20, 2002

(54) Low tire pressure indicator assembly

(76) Inventor: Gary Lapohn, Vermillion, OH (US)

Correspondence Address: VYTAS R. MATAS, 2412 CEDARWOOD RD., PEPPER PIKE, OH, 44124, US

(21) Appl. No.: 09/978,713

(22) Filed: Oct. 16, 2001

Related U.S. Application Data
(60) Provisional application No. 60/241,192, filed on Oct. 17, 2000.

(51) Int. Cl. B60C 23/04

(52) U.S. Cl. 116/34 R; 73/146.8

(57) ABSTRACT

The present invention is drawn to a low tire pressure warning system comprising a tubular assembly threaded on to a tire valve stem and having an internal piston movable therein in response to a differential in tire pressure and present spring forces on opposite sides of the piston to trigger a warning signal such as a red colored strip visible along the housing.

### BACKGROUND OF THE INVENTION

1. Field of the Invention

The present invention relates generally to tire pressure monitoring and pressure indicating systems and more particularly to such systems which will indicate a warning signal upon the tire reaching a predetermined unsafe low pressure condition.

2. Description of the Prior Art

Various tire pressure indicating systems are known for indicating the inflated pressure of the automotive tire tested. Pressure inflation pumps have indicators attached thereto for indicating the tire pressure inflated by the apparatus. There are also hand held indicators for periodically testing the pressure of tires.

On certain truck tire systems, pressure indicating gauges are added directly to the tire indicate the tire pressure and having a red background area in the pressure indicating gauge which indicates an unsafe condition should the indicator needle come to rest in this area. However, the danger area is usually to indicate an overpressure condition which may result in a blowout.

SUV's ( Sports Utility Vehicles) which are basically small covered trucks, have come into vogue and have shown a highly dangerous condition due to underinflation of their tires. Recently, such low tire pressure conditions in SUV vehicles have caused the tire threads to peel from the tire causing the tire to disintegrate and rolling over of such vehicles resulting in death of the driver and passenger. Thus the need for an underinflated or low tire pressure warning system which could be easily attached to each tire of automotive vehicles such as SUVs, trucks and regular passenger automobiles was needed.

### SUMMARY OF THE INVENTION

The present invention solves the problems associated with prior art devices as well as others by providing a simple low tire pressure warning device that easily screws on to the normal tire valve of an automotive type vehicle and which has a red warning indicator that becomes easily visible once the tire reaches a predetermined underinflation point.

To accomplish this goal, the low pressure indicating system has a threaded housing which screws on to the normal tire valve and a check valve that opens the tire valve pressure to a sealed camber found in the housing. The chamber has a movable piston located therein which is spring loaded and may be set to balance the load thereon exerted on it by the pressure in the sealed chamber. When the pressure in the sealed chamber falls a predetermined amount, the piston moves down the chamber and its movement causes a warning signal to be displayed. This warning signal may take the form of a red circumferential area found on the outside of the system housing being displayed, a partial circumferential band on the housing being displayed, or a warning flag to be pushed out of the housing.

In view of the foregoing it will be seen that one aspect of the present invention is to provide a low pressure indicator which may be easily attached to the valve stem of an automotive vehicle.

Another aspect of the present invention is to provide a low pressure indicator which may be easily adjusted for the desired amount of underinflation before the activation of a warning.

Yet another aspect of the present invention is to provide a low pressure indicator which displays an easily seen warning such as a color change.

Still yet another aspect of the present invention is to provide a low pressure indicator which exposes a red warning area upon underinflation being reached.

These and other aspects of the present invention will be more fully understood upon a review of the following description of the preferred embodiment when considered with the accompanying drawings.

### BRIEF DESCRIPTION OF THE DRAWINGS

In the drawings:

FIG. 1 is a cross sectional view taken along a side of an existing tire valve stem having the low pressure indicating system of the present invention screwed on to said valve stem;

FIG. 2 is an expanded view of the low pressure indicating system of FIG. 1 showing a moving sleeve thereof in the low pressure indicating position;

FIG. 3 shows a travel slot for restricting the movement of the moving sleeve of the FIG. 2 embodiment;

FIG. 4 shows an alternate embodiment of the FIG. 1 low pressure indicating system;

FIG. 5 is an expanded top view of the spring calibration wheel used to preset the amount of low pressure before warning activation in both the FIG. 1 and FIG. 4 embodiments;

FIG. 6 is a top view of the rotating collar of the FIG. 4 embodiment.

FIG. 7 is a cut away view of the FIG. 4 embodiment showing the formed helix for rotating the collar of FIG. 6;

FIG. 8 is a cut away view supplemental to FIG. 7 showing the coupling to the rotating collar of FIG. 6; and

FIG. 9 is a top view of a low pressure warning assembly made integral with a automotive hubcap.

### DESCRIPTION OF THE PREFERRED EMBODIMENT

Referring now to the drawings generally, it will be understood that like parts are numbered with the identical numeral in all the embodiments and that they function in a like manner and that the present disclosure is intended to describe a preferred embodiment of the invention and not to limit it thereto.

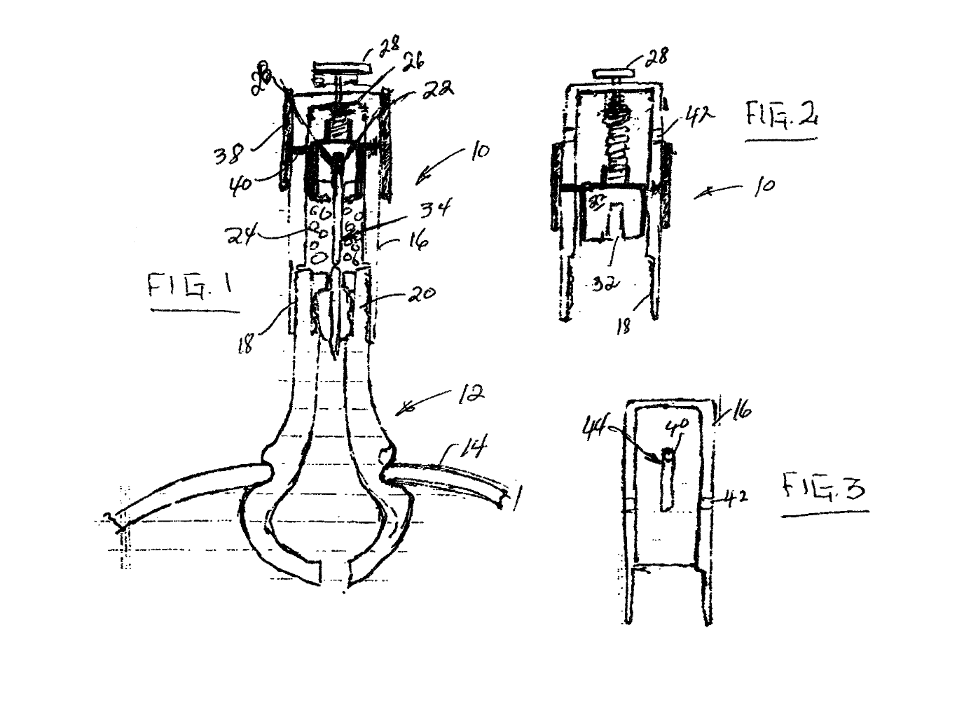

Referring now to one embodiment of the present invention as seen in FIGS. 1-3, a low tire pressure warning assembly (10) is shown screwed on to a known automotive tire valve stem assembly (12) sealably mounted to a tire rim (14) in a known manner The valve stem (14) could also be mounted to a tire tube (not shown) inside the rim (14).

The low pressure warning assembly (1) has a tubular body (16) with an internally threaded section (18) which screws on to an externally threaded portion (20) of the valve stem assembly (12).

Inside the tubular body housing (16) is a plunger (22) which is sealably movable in a known manner within the housing (16) in response to any difference in pressure between a tire pressure communication chamber (24) exerting pressure on one side and the force exerted on the opposite side by a variable force spring (26). The force on the spring (26) is varied by compressing or relaxing the spring (26). The force on the spring (26) is varied by compressing or relaxing the spring (26) having a stem (30) sealably connected to the spring (26) by known sealing means which will allow its rotation such as o-rings. The plunger (24) also has a slotted sections (32) loosely holding a rod (34) which opens a check valve (36) of the valve stem assembly (12) to allow tire pressure air to be communicated to the tire pressure chamber (24) and the plunger (22) when the assembly (10) is fully threaded unto assembly (12).

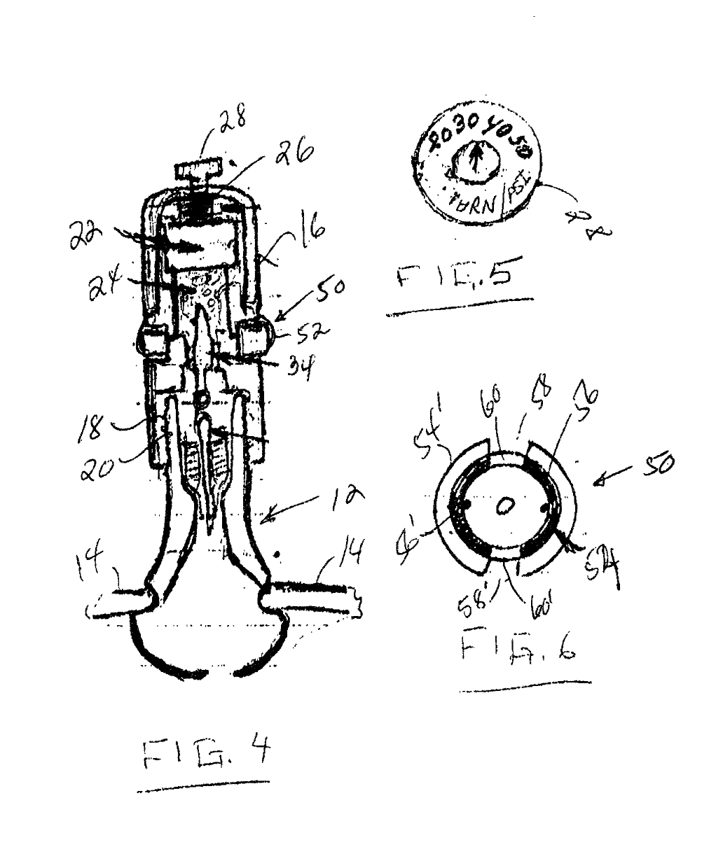

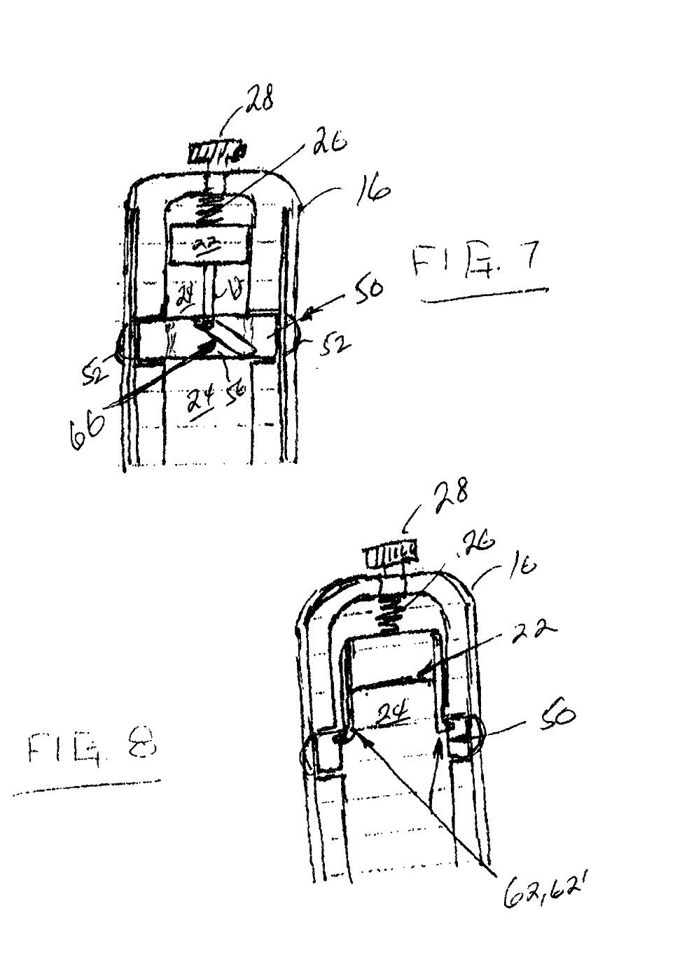

It will be understood that different vehicles require differing tires and hence different tire pressures. As an example, cars require tire pressures of 30-40 psi. RV's and trucks require tire pressures of 40-50 psi while trucks require 50+psi. Hence the low tire pressure assembly must be calibrated for each such situation. This is accomplished by first pressurizing the tire to the desired pressure and then threading the assembly (10) on the valve stems assembly (12) to allow that tire pressure to be communicated to one side of the plunger (22) facing the chamber (24). The calibration wheel (28), best shown in FIG. 5, is then rotated until the described rough psi range is reached. The wheel is calibrated to compress the spring to approximately 1 turn/psi and the wheel is now rotated until it reaches the plunger balance point where the plunger (22) is in a balance position between tire pressure and spring for e. A moving sleeve (38) is externally located around the periphery of the tubular housing (16) and sealably connected to the plunger (22) through a movably sealed pin (40). Thus the calibration which is set to have the moving sleeve (38) cover the top portion of the housing (16) has a red warning band (42) around the circumference calibrated to be approximately 5 psi or 5 turns down from the top of the housing (16). this range is maintained by a slot (44) found in he housing (16) as seen in FIG. 3. Thus the red warning band can be triggered by any low psi differential desired by the driver by simply backing off the calibration wheel 1 turn/psi upon reaching the red warning band with the top of the external member (38) with the red band (42).

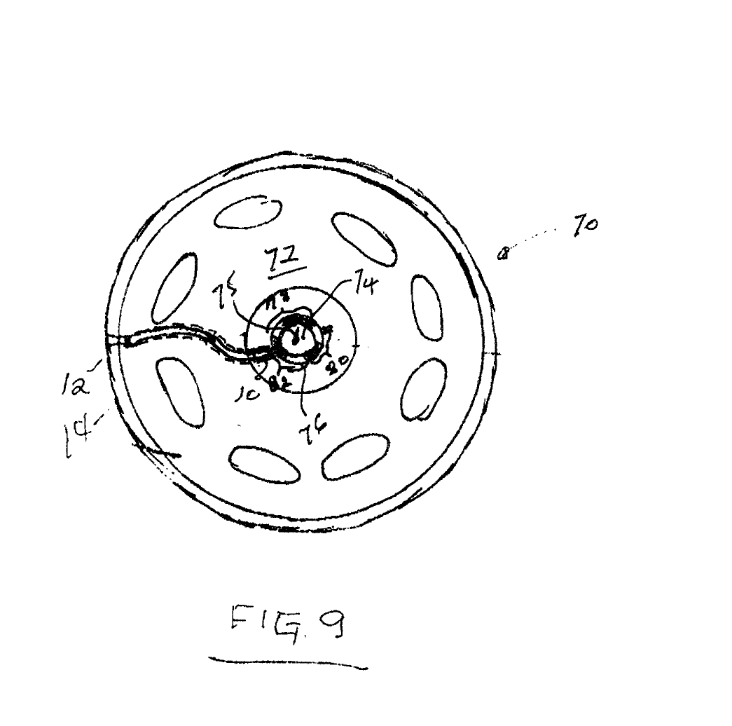

Turning next to FIGS. 4-8 an alternate embodiment is shown wherein a rotating low pressure indicator assembly (50) is now located internally of the low pressure assembly (10) approximately midway down the housing (16). The housing (16) has a transparent section (52) through which the operation of the rotating low pressure assembly may be viewed.

With special emphasis to FIGS. 6-8, it will be seen that the assembly (50) comprises a stationary section (54) and a rotating section (56) internally of the stationary section (54). The stationary section (54) comprises two sections (54, 54′) having two gaps (58, 58′) are colored a non warning color such as black while the rotating colored sections (60, 60′) matching the color of sections (54, 54′) and two warning color sections (56, 56′) such as red. The rotating section (56) is connected to a pair of cam levers (62, 62′) connected to the plunger (22) and rotates in response to any rotation of the plunger (22). The cam levers (62) of the plunger (22) are mounted within a helix (66) machined into the rotating collar member (56) to thus rotate the plunger (22) as it moves within the housing (10) in response to a tire pressure differential and a spring (26) force thereon as was explained earlier.

In operation, the rotating members (56) and the stationary members (54) are aligned at balanced tire pressure and spring force as is shown in FIG. 6 to have only the non warning colors shown at the openings (58). A set tire pressure to be greater than the tire pressure on the plunger (22) and will cause the plunger to move down and rotate, causing the movable members (56) to rotate and expose the red warning color along sections (58 58′) indicating a dangerous tire underinflation.

Referring now to FIG. 9, a low pressure warning assembly (70) is shown which comprises a hubcap (72) having a central gauge (74) located in the middle of the hubcap (72) to prevent any unbalancing of the wheel. The gauge (74) is connected to the valve stem (12) by a known connector (76) located behind the hubcap (72). The gauge (74) has a rotatable indicator area (76) around the periphery thereof to allow the calibration of the gauge (74) for various pressure ranges required for trucks, vans and cars, as was discussed earlier. To accomplish this end, the rotatable indicator area (76) has three ranges (78, 80, 82) for cars,vans, and trucks respectively. Once the tire is inflated to the proper pressure, the rotating dial is rotated to the proper vehicle range. Each vehicle range has a normal color area and a warning color area painted a warning color such as red or orange. The needle (75) of the gauge (76) is aligned with the normal range color and as the pressure of the tire decreases the indicator (75) now points to a warning color area as shown in FIG. 9. Clearly, either the FIG. 1 or the FIG. 4 embodiments could be made integral with the hubcap (72) to replace the gauge (74) and the rotating member (76).

Certain modifications and additions have been deleted herein for the sake of conciseness and readability but are fully intended to fall within the scope of the present invention. As an example, the warning colors could be any bright color such as red, orange, pink ect. Also, a red warning flag could be actuated by the rotating member of the FIG. 4 assembly.

I claim:

1. A low tire pressure warning device adapted to fit on a tire valve comprising:
a housing adapted to sealably fit on the tire valve and having a sealed chamber therein open to the pressure in the tire;
said sealed chamber having a movable piston therein connected to an external surface of said sealed chamber;
means connected to said piston for adjusting the force thereon to balance the tire pressure in said sealed chamber; and
warning signal means connected to said piston for displaying a warning signal whenever the piston moves in response to a loss of tire pressure below said adjusted balanced force on said piston.

2. A low tire pressure warning device as set forth in claim 1 wherein said force adjusting means is a spring.

3. A low tire pressure warning device as set forth in claim 2 wherein said warning signal means comprises a red circumferential area displayed outside said housing whenever said tire pressure fals below said balance force on said piston.

4. A low tire pressure warning device as set forth in claim 2 wherein said warning signal means comprises a partial circumferential band displayed by said housing whenever said tire pressure fals below said balance force on said piston.

5. A low tire pressure warning device as set forth in claim 4 wherein said housing has a transparent section and wherein said partial circumferential band is displayed in said transparent section of said housing whenever said tire pressure fals below said balance force on said piston.

6. A low tire pressure warning device as set forth in claim 2 wherein said warning signal means comprises a warning flag moving out from said housing whenever said tire pressure fals below said balance force on said piston.

7. A low tire pressure warning assembly for cars trucks and van tires comprising:
a tire;
a hubcap having a central gauge for indicating pressure;
a tire valve connected to said central gauge for displaying the pressure in said tire;
a rotatable indicator area connected to said gauge having an indicator area for proper inflation and underinflation for cars, trucks and vans.

8. A low pressure warning assembly as set forth in claim 7 wherein each indicator area has a normal color area and a warning color area indicating underinflation.

9. A low pressure warning assembly as set forth in claim 8 wherein said warning color area indicating underinflation is red.

10. A low pressure warning assembly as set forth in claim 8 wherein said warning color area indicating underinflation is orange.
